(19) United States
(12) Patent Application Publication
(10) Pub. No.: US 2015/0135059 A1
(43) Pub. Date: May 14, 2015

(54) METHOD FOR LEARNING USING LINKED DEVICES

(71) Applicants: Lusha LIANG, Irvine, CA (US); Ping Liang, Irvine, CA (US)

(72) Inventors: Lusha LIANG, Irvine, CA (US); Ping Liang, Irvine, CA (US)

(21) Appl. No.: 14/078,470

(22) Filed: Nov. 12, 2013

(51) Int. Cl. G06F 17/22; G06F 3/147; G06F 17/21

(52) U.S. Cl. CPC G06F 17/2247; G06F 17/217; G06F 3/147
USPC 715/234; 710/72; 715/251

(57) ABSTRACT

This invention include embodiments for using a second device as a companion device to a first device to provide or enhance functions that are better supported using two or more display areas and/or I/O interface concurrently, comprising using a companion device with a first processor and local memory for running one or more programs and a user interface for displaying and/or entering information; a wireless communication link between the first device and the companion device; and, a first program running on the first device and a second program running on the companion device whereas the two programs communicate via the communication link to coordinate the content or information displayed or entered on the companion device with the content or information concurrently displayed or entered on the first device.

This application claims the benefit of U.S. Provisional Application No. 61/725,484, filed on Nov. 13, 2012.

### FIELD OF THE INVENTION

The present application relates to methods for user-friendly ads and monetization of search engine services, methods for transforming a smartphone into a tablet, apps with two or more components running on linked devices, a method for quickly sending a message on a mobile device, a battery-less printed keyboard for mobile devices, and two games.

### BACKGROUND

Prior art tablets and eReaders, such as Apple iPad, Amazon Kindle, Barnes and Noble Nook Color, etc., hereafter all referred to as tablets, are more suited for casual reading. It is possible to take notes in prior art tablets, but the notes and the reading content are limited to the same screen, which typically is not large enough to give sufficient display areas to both. To display sufficient content of either one, prior art tablets use the entire or most of the screen to display one of them, either the reading content, or a note, Thus, when one is displayed, the other or most of the other is not viewable or can only be viewed in a small area. For more intensive or work related reading, a reader usually needs to take notes (extensive notes sometimes), write summary, and/or make drawings, while the reading content is viewable so he can frequently copy, quote, or refer to the reading content. This is especially the case when reading scientific and technical contents. This is often how reading or studying is done with books printed on paper and paper notepad. Readers are accustomed to this style of reading and learning process. Thus, it is highly desired that sufficient amount of both the reading content and corresponding notes or drawing are viewable, side by side, when reading or studying using a tablet.

In the following descriptions, the term tablet preferably refers to a tablet or eReader device such as an iPad, Android tablet, Kindle or Nook, but the descriptions are equally applicable to a smartphone, a portable game player, a notebook computer or other mobile device, and thus may be interpreted as referring to any one of those. In the following descriptions, the term book may mean an electronic book in any format (e.g., ePub, txt, html, pdf, etc) or any electronic document or file (e.g., Word, txt, html, spreadsheet, pptx, pdf, flash, mpeg, wmv, h.264, etc.) which may contain information of any formats, e.g., texts, images, audio, or video.

There is no prior art that provides the functions of the embodiments presented in this invention.

### BRIEF DESCRIPTION OF THE FIGURES

FIG. 1 shows the link and synchronization between a reading app on a tablet and a note taking app on a companion device.

FIG. 2 shows the touch screen of a companion device being used as a keyboard for a tablet.

FIG. 3 shows a carrying case to carry a tablet and a companion device together.

### DETAILED DESCRIPTION OF THE PRESENT INVENTION

Reference may now be made to the drawings wherein like numerals refer to like parts throughout. Exemplary embodiments of the invention may now be described. The exemplary embodiments are provided to illustrate aspects of the invention and should not be construed as limiting the scope of the invention. When the exemplary embodiments are described with reference to block diagrams or flowcharts, each block represents both a method step or an apparatus element for performing the method step. Depending upon the implementation, the corresponding apparatus element may be configured in hardware, software, firmware or combinations thereof.

One embodiment of this invention is a method for using a second device as a companion device to a first device, e.g., a tablet as defined above, to provide or enhance functions that are better supported using two or more display screens and/or I/O interface concurrently, e.g., side by side note-taking while reading a book or document, searching or browsing, viewing related or expanded information, in-context discussion, etc., comprising using a companion device with a first processor and local memory for running programs; a user interface for displaying and/or entering information, e.g., a touchscreen that can be used both as a display and for entering using a finger or a stylus; a communication link, which can be through a wired or wireless communication module embedded in the companion device and coupled to the first processor, for communicating with a tablet which is embedded with a corresponding wired or wireless communication module; and a first program running on the companion device and a second program running on the tablet, whereas the two programs communicate via the communication link to coordinate the content or information displayed or entered on the companion device with the content or information concurrently displayed or entered on the first device. Note that a companion device may be a device specifically made to function as a companion device to a first device, or be an existing mobile device such as a tablet, smartphone, a notebook computer or other mobile device.

Entering information may be accomplished by typing or otherwise entering texts, drawing on a touchscreen using a finger or stylus, taking a picture or video using a camera embedded in a tablet or companion device, recording an audio message, importing a picture, video or audio file from a gallery or folder stored in a tablet or companion device or from a URL, etc.

In a preferred embodiment, a companion device is powered by its own battery. In another preferred embodiment, the communication link between a tablet and a companion device is wireless. One example wireless communication link uses Bluetooth modules in the companion device and the tablet. A user interface is provided for a user to pair and/or connect the two devices to establish the Bluetooth link so that the first and second programs can communicate with each other. Another example wireless communication link uses near-field wireless communication modules in the companion device and the tablet. Yet another example wireless communication link uses wireless LAN/Wifi such as 802.11a/b/g/n/ac. In one embodiment, the companion device and the tablet are on the same WLAN/Wifi network and share the same Access Point, and the local IP address (e.g., 192.168.1.100) and port number (e.g., 8191) on one device is entered into a second device, and information is transmitted using the local IP address and port number.

In the descriptions below, writing or entering a note means entering or designating any information, including but not limited to entering texts, making a drawing, and/or adding a picture, video or audio message, either from a gallery on a device or using a camera and/or microphone to record information. In one preferred usage scenario, an app is provided on a tablet for a user to read a book, and while a user is reading a book, a second app is provided on a companion device for the user to write one or more notes about one or more places or contents on the page of the book on the tablet. The first app and the second app communicate and automatically link the notes with the page the user is reading. To enable the user to link a specific note to a specific place or content on the page, the interface may further allow him to select the place by tapping, clicking or otherwise indicating the place or select the content on the tablet and indicate the specific note to be linked with the selected place or content. Upon the user's indication, the first app and the second app communicate and link the specific note to the selected place or content in the book. After a page, or a place or content on a page is linked to a note, the next time the user flips to the same page of the book on the tablet, the embodiment can automatically display the linked note on the companion device. Vice versa, when the user flips to the same note on the companion device, the embodiment can automatically display the linked page or content in the book on the tablet.

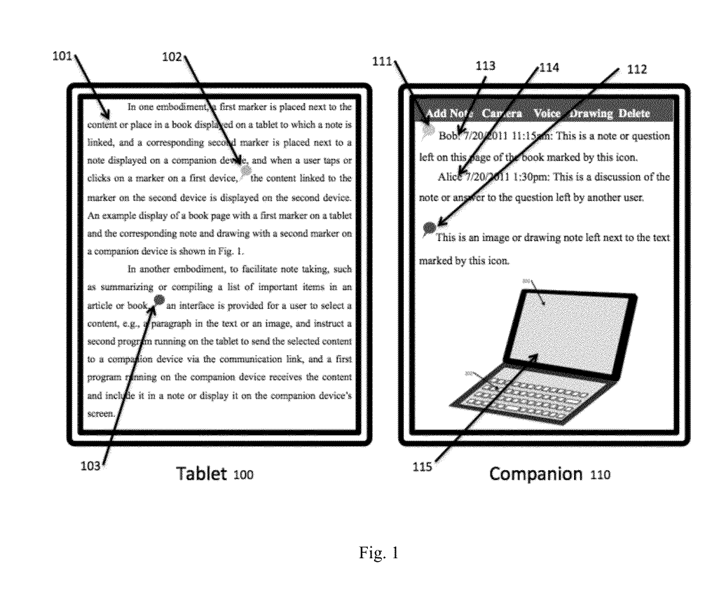

An example display of a book page 101 with a first marker 102 and 103 on a tablet 100 and the corresponding note 113 and drawing 115 with a second marker 111 and 112 respectively on a companion device 110 is shown in FIG. 1. In one embodiment, a first marker 102 is placed next to the content or place in a book 101 displayed on a tablet 100 to which a note is linked, and a corresponding second marker 111 is placed next to a note 113 displayed on a companion device 110, and when a user taps or clicks on a marker on a first device, the content linked to the marker on the second device is displayed on the second device.

In another embodiment, to facilitate note taking, such as summarizing or compiling a list of important items in an article or book, an interface is provided for a user to select a content, e.g., a paragraph in the text or an image, and instruct a first program running on the tablet to send the selected content to a companion device via the communication link, and a second program running on the companion device receives the content and include it in a note or display it on the companion device's screen.

The above embodiment can be further extended to provide an interface to enable a user to designate multiple notes, or multiple pages of notes, as corresponding to a place or content in a book, or designate a note to correspond to multiple places or contents in a book, or designate a place or content in a book to correspond to multiple notes.

In one embodiment tailored for a structured or group learning environment such as a course taught by an instructor or in a study group, or in an open or social learning setting such as sharing with users in a social network or on the Internet in general, notes entered by one or more users, e.g, 113 by Bob and 114 by Alice, may be made accessible to a first user. Thus, when a first user reads a page in a book on a tablet, the notes entered by other users may also be displayed on a companion device either automatically or when selected by the first user. The notes entered by other users may be displayed using a different format, e.g., color or font, to distinguish from a user's own notes, and/or from each other.

In one embodiment, a search function may be provided for a user to search the notes entered by one or more users. The search may be by tags, keywords, audio signal, image or video similarity or their descriptions, and/or by user name if there are notes from more than one user accessible. In another embodiment, a user interface is provided for a user to browse the notes by tags or keywords, in which a tag cloud or keyword cloud is displayed where the tag cloud or keyword cloud is generated by analyzing the collection of notes entered by one or more users, and when a user clicks or taps on a tag or keyword, a list of notes containing that tag or keyword is displayed.

In another embodiment, notes entered by a first user may be shared with other people, and interface is provided for the first user to choose to share a note with other people, or share some or all notes with other people. One way of sharing is to publish or otherwise make a note accessible to a social network to which the first user and the people he wishes to share with belong, e.g., a shared note may be displayed or published as a Facebook news feed, status update, wall post or note. Another way of sharing is to show a shared note or make a shared note accessible to a second user when the second user reads to the same place in the same book where the note is associated, e.g., show the note automatically on a companion device or using embodiments of this invention, or show an indication of the existence of a shared note inside or on the margins a book near the place or content to which the note is associated, and when the second user taps or clicks on the indication, the shared note is displayed on the tablet or on a companion device. To distinguish the notes added by a first user and a second user, different indications may be used, e.g., icons of different colors may be used. Furthermore, an interface may be provided to enable a first user to choose which second users to share the notes with, and only the selected second users will be able to view the shared notes. In yet another embodiment, when a note is shared, when the note is displayed, a user interface is provided to enable the first and second users to carry out a discussion about the notes or associated contents, and the discussions are displayed or made accessible to all users with permission to the shared notes.

In a preferred embodiment, to keep down the size, weight and cost of the companion device, the majority of the functions described above, such as those that require heavy processing and/or large storage, are performed in the tablet, and the companion device functions mainly as a secondary display and I/O device. The companion device uses the minimal number of components to support its function of entering and viewing notes and coordinate with a tablet. In one embodiment, the companion device has a communication module for communicating with a tablet (e.g., Bluetooth), but no other wired or wireless modules (e.g., no 3G or 4G, no Wifi) for connecting to the Internet or a local network. The speed of the first processor and the size of the local memory in a companion device can also be kept to minimum. In one embodiment, a companion device may not have a camera or microphone, the user interface for taking of a picture or video or voice recording to add to a note is provided on the companion device, but the actual taking of a picture or video or voice recording is performed on the tablet, and the picture, video and/or voice content is displayed or played on the companion device. In another embodiment, notes are stored in the tablet and transmitted to or from the companion device via the communication link as needed. Since the companion device may have only limited processing power, in yet another embodiment, both a first app and a second app are executed on the tablet, but the user interface of the first app is displayed on the tablet and the user interface of the second app is displayed on the companion device. Both apps are installed and executed on the tablet and the companion device is used as an I/O and display for the second app. In yet another embodiment, if the companion device has enough processing power to execute a second app, a first app is executed on the tablet with its user interface displayed on the tablet, and a second app is executed on a companion device and its user interface also displayed on the companion device, but when the second app requires connection to a server or to a network, the companion device accesses the server or network through the tablet using the communication link with the tablet, that is, the companion device forwards the second app's request and data to the tablet which completes the connection to the server or network and pass the data back to the companion device, and to the second app.

One embodiment includes a handwriting recognition function that converts a handwritten note entered by a user on the companion device into typed texts or computer drawing. In another embodiment, handwritten data or drawing is transmitted to the tablet to which the companion device is coupled via the communication link, and a program running on the tablet's processor accepts the transmitted handwritten data and performs handwriting recognition to convert the handwritten data to computer data, e.g., typed text, or regularized or improved drawing.

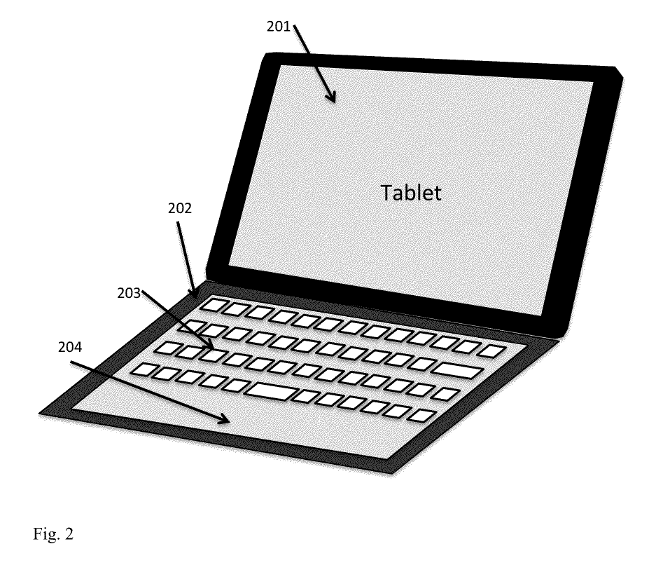

In yet another embodiment as illustrated in FIG. 2, a setting selection is selected for using the companion device 202 as a keyboard for the tablet 201, and upon a user selecting this setting, a virtual touchscreen keyboard 203 is displayed on the companion device and the companion device functions as a keyboard for a tablet to which the companion device is coupled via the communication link. Data entered on the companion device is transmitted to the tablet via the communication link, e.g., Bluetooth. Furthermore, when a companion device functions as a keyboard to a tablet, an area 204 on the companion device's touchscreen may be used as a touchpad to move the cursor on the tablet.

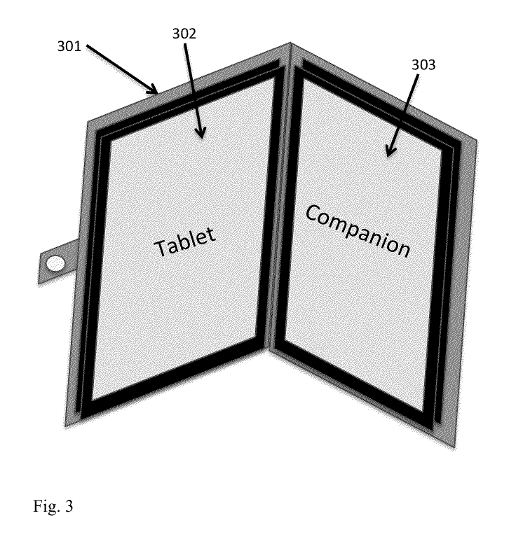

Another embodiment of this invention includes a special case 301 to hold a tablet 302 and a companion device 303 together so they can be easily carried in one piece, as illustrated in FIG. 3. The case may further include a stand that stands either or both of the tablet and the companion device in a desired angle for viewing or entering data. One particular standing position stands up the tablet while the companion device lays flat or slanted so it can be used as a keyboard for the tablet. If the communication link between the tablet and the companion device is a wired connection, a connector for the tablet and a connector for the companion device are embedded in the case, and when the tablet and the companion device are inserted into the case, the connectors will be inserted into the corresponding connection ports on the tablet and companion device. In yet another embodiment with wired communication link between the tablet and the companion device, the companion device is built in with the case.

The applicability of this invention is not limited to the above descriptions. The method of using a companion device to expand the functionality of a tablet can be used to provide a secondary display or user interface for a plural of functions to enhance the functionality and user experience of using a tablet. This includes, but is not limited to, providing a second user interface on a companion device to any applications running on a tablet in which when viewing, interacting, reading, entering or editing a first information or content in a first user interface on a tablet, a second user interface on a companion device is desired to allow a user to view, interact, control, refer to or edit either the first or a second information or content side by side with the first user interface. The second user interface can be for reference, cross check, comparison, or providing a context or background, or additional, enhanced or alternative control, or an overall or alternate view. Examples include, but are not limited to, the following:
Entering, viewing or editing an event in a calendar on the companion device while displaying the daily, weekly or monthly calendar or events on the tablet to provide a context of the new event in relation to other events in the calendar and an overall view of the user's schedule for the day, week or month.
Displaying a first part in a file on the tablet and displaying a second part in the same file on the companion device, where a file may be a text document, source code of a program, an ebook or pdf file, a web page, a video, a photo or an album of photos, or other media files. For example, display page 110 of an ebook which contains definition 3.2 or theorem 4.7 on the tablet and display page 258 of the same ebook on the companion device which contains the proof of a new theorem 5.8 that refers to definition 3.2 or theorem 4.7. In another example, display one photo in full on the tablet and display a zoomed-in part of the same photo on the companion device so the user may look at the details of the zoomed-in part of the photo and at the same time see the relationship of the zoomed-in part in the full photo. In another example, display the full view of a webpage on a tablet and display a zoomed-in part of the same web page on a companion device, or display a blog post one a tablet, and display comments on the blog post on a companion device. In yet another example, play a video starting at time 1:02 on the tablet, and play the same video starting at time 3:59 on the companion device.
Displaying a first part in a first file on the tablet and displaying a second part in a second file on the companion device, where a file may be a text document, source code of a program, an ebook or pdf file, a web page, a video, an album of photos, or other media files. For example, display page 110 of a first ebook which contains definition 3.2 or theorem 4.7 on the tablet, and on the companion device display page 97 of a second ebook, which deals with the same or related subjects as the first ebook and contains a definition that is related to definition 3.2 in the first ebook, or a proof to a theorem that is the same or related to theorem 4.7 in the first ebook. In another example, display a first photo on the tablet and display a second photo on the companion device so the user may compare the two photos side by side. In yet another example, play a first video starting at time 1:02 on the tablet, and play a second video starting at time 3:59 on the companion device, so that the user can compare the events and time sequences of events in the two videos.
Displaying a first content of a book or document on a tablet and displaying an illustration, animation, video or other supplementary content or media related to the first part on a companion device, e.g., on a networked TV; Displaying a first page in a PowerPoint presentation on a tablet and displaying notes related the first page on a companion device; Playing a first scene of a movie on a tablet and displaying supplementary or background information or content related to the first scene on a companion device.
Browsing a webpage on a first device and adding an annotation or markup on the webpage on a companion device such that when a user browses this webpage in the future, the annotation or markup corresponding to this webpage can be displayed on a companion device.
Watching a video on a tablet and displaying discussions about the video, in-video comment, background information, or expanded or additional image or video scenes on a companion device. Or reversely, watching a video on a paired companion device, e.g, a TV, and displaying discussions about the video, in-video comment, background information, or expanded or additional image or video scenes on a tablet.
Instead of having to switching between a map format and a list format in a navigation app such as Google Map Navigation on Android devices, displaying the navigation map on a tablet and displaying the driving instructions in a list format on a companion device, or vice versa.
Playing a game one a tablet, using a companion device to provide an additional user interface for displaying an expanded scene, or additional information or game scenes, and/or providing additional, enhanced or alternative controls to the game executed on the tablet, or vice versa.
Taking picture or video using one device, e.g., performed by a first user using a smart phone, and adding notes or annotations of the picture or video on a second device, e.g., performed by a second user using a tablet, and automatically associate the notes or annotations with the corresponding picture or video.
Displaying a first content of a book or document on a tablet, and displaying a thread of discussions in a discussion forum related to the first content or about the book or document on a companion device, or vice versa.

In the above embodiments, notes or discussions can be saved in the companion device or saved in the tablet in which the reading material, e.g., book or document, is saved, so that when a companion device is not present or available, the notes or discussions can be viewed on the tablet itself by opening another display window instead of on a companion device. The role for information display and/or I/O can be exchanged or reversed between a tablet and a companion device, e.g., a companion device is used to display a book, and the notes are displayed or entered on a tablet, but the main functions may still be executed in the tablet, the companion device simply functions mainly as a display for the tablet.

The invention is not limited to the hardware of a companion device. In one embodiment, a second tablet or smartphone or other device is used as a companion device to a first tablet or smartphone or other device, and both the first and the second devices run the software of this invention to provide the coordination or synchronization between the two devices to provide the functions of this invention. Smartphone processors are becoming increasingly powerful, and can support applications that can be better displayed and/or interacted with on a larger display screen. However, the form factor requirement of the phone function dictates that the size of a smartphone may not be too large. One embodiment of this invention is a method for extending the user interface of a smartphone comprising using a low cost companion display and I/O device which has a display screen or touchscreen larger than that of the smartphone and is powered by its own battery; a communication link, which can be either wired or wireless, connecting the companion device and a smartphone; Executing one or more apps on a smartphone but using a companion device for the user interface, e.g., display and I/O, while the smartphone screen may be turned off to save its power, or turned on as an additional display or I/O interface.

More generally, users often have two or more mobile devices, e.g., a smartphone, a tablet, a portable game player such as the Nintendo DS or Personal PlayStation, and a laptop or notebook computer. In prior arts, these personal mobile devices functions each on its own and the connection among them is limited to synchronization, copying or sharing of contents, e.g., sharing bookmarks, browsing history or files. Embodiments of this invention provide enhanced functions and better user experiences of a first app by providing some first functions of the first app using a first component app whose display and/or I/O is on a first device and providing some second functions of the first app using a second component app whose display and/or I/O is on a second device, and the first and second devices are linked by a communication link and the first and second component apps coordinate with each to provide the complete function of the first app. The embodiment can be generalized to more than two component apps and/or more than two coordinating devices. In one embodiment, the first component app is installed and executed on the first device, and the second component app is installed and executed on the second device. Furthermore, in this embodiment, each of the component apps may be able to function alone as an independent app on its own host device. In another embodiment, both the first and the component app are installed and executed on the first device, and the second device simply provides the display and/or I/O for the second component app. Furthermore, in this embodiment, all the component apps may work together on the first device to provide some or all of the functions of the first app without the second device, e.g., when the second device is not available or not linked, by using the only the first device for the display and/or I/O of all component apps. One of the component app may function as the main app, and another component app may function as a companion app. For example, the embodiments of a reader app (which may be considered as the main app) on a tablet and a notes or discussion app (which may be considered as a companion app) on a companion device functioning together as a study app, or a video player app (which may be considered as the main app) on a tablet and a background information or commenting app (which may be considered as a companion app) on a companion device functioning together as a video app.

The communication and coordination functions required of each component apps of a first app may be developed and integrated into each component app, or may be provided as functions of an operating system or a middleware across multiple operating systems, and an API, function calls or integration points are provided which each component app can call to invoke the functions required to support the multiple device communication or coordination functions.

This invention is applicable to any methods, software, or hardware that provides the linked, coordinated or synchronized functions between two devices. The two devices can be any devices that have means to communicate between them either wired or wirelessly, such as one tablet and one companion device, one smartphone and one companion device, one smartphone and one tablet, two full function tablets, one notebook computer and one tablet, one notebook computer and one companion device, etc. Therefore, in the many embodiments of this invention, the tablet used in the descriptions can be a tablet, an eReader device, a personal computer or a smartphone, and a companion device can be a device specifically made to implement the embodiments of this invention, another tablet, an eReader, a smartphone, a personal computer. In one embodiment, a reading app is executed on a tablet for reading a book or document, an app for taking or notes or discussion related to the book or document is executed on a personal computer, e.g., a laptop or notebook computer, or a desktop computer. Alternatively, a reading app is executed on a personal computer for reading a book or document, an app for taking or notes or discussion related to the book or document is executed on a tablet.

In one embodiment, one first device can be paired with and serve as the companion device for two or more second devices. In another embodiment, a first device can be a companion device for a second device for one application, and the same second device can be a companion device to the first device on another application. In yet another embodiment, a first device can be a companion device for a second device for one application, and a third device can be a companion device to the first device on another application. In yet another embodiment, a first device may be paired with and use two or more second devices as companion devices in an application.

### Communal Learning Embodiments Using Two or More Display Areas

Learning is often more effective when it is done in a group or communal environment, such as in a study group or book club. The additional display space provided by a companion device lends well to in-context discussions, questions and answers among a group of users. The embodiments below are inspired by the companion device described above, but are not limited to companion devices. The embodiments below uses two display areas, which can be one tablet and one companion device, or two tablets or other portable devices, or one tablet or computing device and a second display screen only device (which has no other functions), as long as the two devices have a communication link between them, either one or both of them have a network connection so devices of multiple users can communicate. It is also applicable to one device with a large display screen that can be divided into two display areas, such as a laptop or desktop computer, or a tablet with a large screen or with two screens. Thus, the first and second display areas referred to below may refer to the display screen of two devices, or two display areas on the screen of one device.

One embodiment of this invention is a method for in-context discussion or questions and answers to support communal or group learning comprising providing a first display area and a second display area to each user on one or more network-connection devices, a wired or wireless communication link between the two display areas, and the following steps:

Using a user interface displayed in a first display area, a user specifies one or more first documents as the base document(s). To specify a base document, the user may select a document from a list of documents (e.g., displayed in a browser or an app), or upload one or more first documents to a server or through other means making one or more first documents accessible to a group of users. A user, e.g., an instructor or leader, may also generate a customized first document (e.g., a textbook for a course) by selecting parts from several documents (e.g., books, journals, web pages). In some cases, an instructor may like to use materials from several books to better cover the scope of a course or offer better understanding of the subject. Using prior art printed books or eBooks, this would be difficult for the students because of the high cost of textbooks. This embodiment enables a customized electronic book to be generated wherein a student only needs to pay for the parts of materials used from each book, instead of paying for the full costs of all the books used.

After a first document is specified, the embodiment displays a first document in a first display area, and may accept from a user one or more position-specific or content-specific first markups, which can be placed inside or along the margin of a first document displayed in a first display area, and records a first markup and a specific first position at which or a specific content to which the first markup is to be placed. The content at or near the first position where the first markup is placed, or the specific content to which the first markup is associated, is referred to as the first content. A first markup may be a symbol, graphics, drawing, pointer, text or text box, highlighting, underline, coloring, or icon (e.g., textual or graphical) that is linked to one or more first apps that are related to or supplements the first content. A first app may be a discussion forum, a question and answer session, a microblog or status updates, an interactive program, a video, audio or other media file, an animation, part or whole of a second document. A representation of a first markup and/or first app may be automatically displayed in the margin or along the side of a first display area or in a second display area when the associated first content is displayed in the first display area. A representation of a first markup and/or first app may be a symbol, icon, text or text box with a title or short description of the first app, or other indications of the presence of a markup and/or an associated first app. A color coding scheme, or a connecting line, or icons of the same shape, or other means may be used to indicate that the representation or the first app is associated with the first markup.

When a reader of a first document accesses or views a first content in a first document in a first display area or interacts with a first markup or the representation of the associated first app, the associated first app may be opened or displayed to the reader in a second display area. Interaction with a first markup or the representation of the associated first app may be clicking, tapping, moving a cursor or other indicator, on the first markup or the representation, or a finger gesture on a touch-screen. A first app may also be opened or displayed in a second display area when a user interacts with the associated first content, where an interaction with a first content may be clicking, tapping, floating a cursor or other indicator, or making a finger gesture on the first content, or simply displaying the first content in a first display area. Displaying the first content in a first display area and the associated first app in a second display area side by side enables a reader to access or view the content in the first app, e.g., discussions, and its context, e.g., the first content that is being discussed.

Furthermore, in the case of a first app that contains specific content of a second document, when a user interacts with a first markup or the representation of a first app, the part in a second document where the specific content is located may be displayed to the user. The specific content in the second document may be highlighted or marked otherwise to bring it to the attention of the reader.

An example of a first document with a first markup displayed in a first display area, and a first app displayed in a second display area is similar to the one illustrated in FIG. 1, but the two display areas may be on the same device or on two separate devices.

A content specific first markup and the associated first app may be attached to more than one position at which the specific content appears. In one embodiment, a user specifies the specific content to which a first markup is to be placed and the associated first app to be attached, a program finds one or more, or all locations where the specific content appears, and automatically attaches the first markup and the associated first app to the locations where the specific content appears.

Furthermore, the embodiment can accept from a user additional content that supplement a first content in a first document, e.g., an animation or video explanation of a first content, an interactive program that shows the effects when a reader changes one or more parameters as discussed in a first content, a new derivation of a formula or a different proof of a theorem in a first content, add a first markup by the first content, link the first app with the first markup, and make the first app accessible to users of the first document. This opens up a first document to content contributions by others so that they can add their perspectives and insights, creative work, or interactive contents to specific positions or specific first contents in a first document, which may help readers gain a better or deeper understanding or a different perspective than those offered by the first document. This is in contrast to the traditional published documents or ebooks, e.g., printed textbooks or prior art ebooks, which are limited to the views and explanations of the author(s). For example, in a digital signal processing course, some students may have trouble understanding the concept and significance of discrete Fourier transform from reading a conventional digital signal processing textbook. A user, e.g., a developer, other than the author of the textbook may develop an app which enables a user to interactively add up or change components in a Fourier transform to see the effects of how adding sinusoidal components can gradually approximate a signal waveform with increasing accuracy. The developer may add a first markup in the textbook where the content of Fourier transform is introduced, associate this app with the first markup, and make this app accessible to readers of the textbook. A reader of the textbook will then be able to access and interact with the app when he reads the content on Fourier transform in the textbook to gain a better understanding of how multiple sinusoidal waves can add up to approximate a signal waveform and how the accuracy of approximation improves as the number of sinusoidal waves used increases. Other examples of first apps are animations that illustrate or explain a scene or process described by the first content, (e.g., a physical, biological or chemical process such as nuclear reaction, cell growth, fuel cell reaction), or demonstrate operations or procedures described by the first content, (e.g., steps in using a software or performing a surgical operation); an interactive program that accepts user inputs to change the information displayed (e.g., an app that demonstrates a principle, equation or process described by the first content to help a user gain a better understanding of the first content where a user can change one or more parameters or elements to see how they affect the outcome, such as manipulating charge particles to see how they affect the electric force field, changing a filter's Fourier spectrum to see how it affects an output signal, changing the structure and material of a MOSFET to see how it affects the I-V characteristics and the leakage current). Such apps, hereafter referred to as Book Apps (although it is not limited to books, e.g., they can be added to research papers in academic or technical journals, or any other documents), may be developed by a person other than the author of a document and offer readers a perspective that is different from or easier to perceive or understand to some readers than that provided by the author of the document. These Book apps make learning and reading an open, expandable, social and interactive process that is in-context, rather than the conventional lone reader and passive understanding limited solely to materials provided in a printed book or a conventional ebook.

The embodiment may further comprises providing a platform for accepting submissions of one or more first apps from one or more developers for linking into a first document with one or more associated first markups inserted at specific position(s) or specific content(s) of the first document. It may further comprising providing mechanisms to monetize the first apps, including charging a fee for accessing a first app or including advertisement inside a first app. The developer of a first app may be paid a portion of the income from the sale of the app or received revenue from the advertisement placed inside his app. This enables and motivates more people to provide additional contents or perspectives to supplement a document or help readers achieve a better understanding of the content. This embodiment may further comprises providing a marketplace of the first apps, which may be referred to as Book Apps, for a first document wherein descriptions of one or more apps may be listed in a directory or along the side of the associated first contents, and users of the document may select, request to gain access to, install or purchase an app, either free or paying a fee, to gain information, perspective or understanding that is provided in or enabled by the app. This is especially useful for science and engineering textbooks that contains concepts, processes or relations that may be difficult to understand, and better understanding may be gained from an animation, an illustration, a different perspective or explanation, or an interactive program where a user can see the effects of changing the various factors. This is similar to the App Store or App Market, such as the one for iPhone and iPad or the Andriod devices, but it is significantly different and new because there are no Apps or Apps market specific to contents or positions in one or more documents in the prior art, and the apps in this invention are associated to one or more specific first documents and are document or position or content specific, which is novel and significantly different in comparison to prior art app market. Prior art app markets are associated with and limited to a hardware device or an operating system. This invention establishes a market place for the Book Apps where other people can contribute to expand content of a document or help the understanding of its content, and get compensation from their work. The embodiment may further comprise an approval process for the apps submitted by developers, and each app may have a discussion forum as part of the app. The Book Apps and the associated Book Apps Market embodiments liberates a book from the limitations of time, resources, imagination, or perspectives of its author(s), and enables a book to become open-ended and provides the platform and motivation for a book to be supplemented by interactive or creative contents from many developers. This is revolutionary to the textbook market.

In addition, a first app may accept and display markups and apps inside a first app. The apps inside a first app, referred to as nested apps, can be inserted in a similar way as how first markups and the associated first apps are treated in a first document, basically treating the content of a first app in the same way as a first document.

Readers' reviews or ratings of a first app may be displayed to a user. A summary rating may be displayed in a representation of the first app. A user may click or tap on a summary rating to access detailed reviews. The summary ratings or the detailed reviews will enable a user to decide whether to access the first app based on feedback from other readers.

There are many types of platforms (hardware or software or a combination of both) on which a document may be accessed or read, e.g., Windows PC, Mac, iPad, Chrome OS tablet or web pad, Android mobile devices. One embodiment of this invention provides a development interface or API so that a Book App developed by a developer using the development interface or API can work on devices of multiple types of platforms (e.g., Windows PC, Mac, iPad, Chrome OS tablet or web pad, Android mobile devices) supported by the development interface or API. This makes the Books Apps platform-agnostic. The development interface or API may be implemented by a middleware layer on more than one type of devices, wherein the middleware layer on a device handles the specific interface to the device platform and presents a common interface to Book Apps.

In another embodiment, a Book App is hosted on a server as a web app and the server renders the app on devices with different hardware and/or software through a user interface such as a browser or a customized user interface app installed on a device.

A Book App written for one document may be applicable to other documents as well. For example, an app that provides an interactive electromagnetic field which a user can manipulate and see the effects can be made available to several physics textbooks that cover the topic of electromagnetic field. One embodiment makes a Book App accessible to more than one document by finding related or similar content in each of the books and placing a markup on a page with the related content, wherein the markup is linked to the same Book App. Additional information specific to a book may also be used to customize the Book App.

Another embodiment uses a first app referred to as a Lecture Media App (LMA), which is an app that (a) is associated with certain part(s) of a document, e.g., a section or a chapter of a textbook, and (b) contains audio and/or video media which lectures or talks about the contents of the certain parts of the document, e.g., a video of a lecture about a chapter of a book given by a professor. Same as in a marketplace of Book Apps, more than one party can produce LMAs for a content in a document and a plural of LMAs may be made accessible from the document using one or more markups. For example, professors from a plural of schools teaching the same course or teaching courses using the same textbook or similar textbooks may produce LMAs for the textbook(s) and a plural of the LMAs may be offered to students enrolled in a school from within the textbook(s) when they read the related contents. Students can then select an LMA to his liking or view more than one LMA to get a better understanding or broader perspectives. Readers' reviews or ratings of an LMA may be displayed to a user to enable a user to select whether to access the first app based on feedback from other readers.

In one embodiment, when an LMA is being played in a second display area, the system may either automatically turn pages of a first document in a first display area or ask a reader or viewer to turn to specific pages that are synchronized to the lecture, may automatically show in a first display area highlights or markups or pointers in the document matching what the audio or video content is talking about. For example, when a video shows in a second display area a professor saying “Look at equation 6.3”, “See the trend in FIG. 3.5”, “Check out the data in Table 8”, “Notice the condition of this theorem”, “The definition given in this paragraph”, the corresponding content in the document is displayed and highlighted in a first display area. When the lecture refers to more than one part in the document, more than one part is displayed to a reader so that the reader can correlate them. For example, when a professor states in a video lecture, “This step in the derivation of theorem 18 on page 58 is based on theorem 7 on page 39”, both the derivation step of theorem 18 and body of theorem 7 in the book are displayed to a reader in two split windows in a first display area.

In either one or both of the first display area and the second display area, an app may use split windows to display related contents. The second window may be the destination of a link in the first window or in the first markup or first app associated with the first window such that clicking on this link opens the second window or splits a window into a first window and a second window to show both the contents referred to and the referring content.

A first document may have many markups and associated apps. One embodiment provides a list of all markups on a page of a document, in a portion of a document, or in the entire document. By interacting with an item in the list, a user may directly access the first content, the associated first markup or first app. A search function may also be provided so that a user may find a first markup and the associated first app by searching for the first content in the first document to which the first markup and first app is associated, the contents in the markups or the associated apps. In addition, an index may be generated for contents in markups and the associated apps so that a user may browse the index and find the markups or the associated apps that contain an index term by following a link associated with the index term.

If the first document is a video or other active content, the playing of the content of the first document may be paused when a user is (a) interacting with a first app such as reading or viewing content in a first app or is entering information into a first app, or (b) creating a markup or the associated app. The playing of the content of the first document may be resumed when the user finishes interacting with a first app or when a first app is closed, or when the user finishes creating a markup and the associated app.

In a first document with many markups and associated apps, the embodiment may provide an interface for a user to select to view first markups or first apps added by one or more specific creators (i.e., select by user name of the user who created or added the first markup and first app), by types of the first markups or first apps (e.g., select to view only first apps with video or animation), by dates (e.g., select to view only markups and apps added since yesterday, or in last week).

Another embodiment of the invention is a method for interactive reading or discussion about one or more documents by two or more types or groups of users using a first display area and a second display area. For example, a first type of one or more users who are leaders (a leader is a type of user who can perform functions other users cannot, or can give instructions to other users, e.g., an instructor of a course, a leader of a research project or group, leader of a group such as a department in an organization, a study group or a book club), and a second type of one or more users who are readers or viewers (a reader or viewer is a type of user who reads, views or reviews a document, and may participate in discussions, asks questions or exchanges ideas with other users, e.g., students, research or study group members, or book club members). A leader may select or invite users to join a group, or grant access to a document, first markups and first modules to other users. Other examples of groups of users may be a group of all teaching assistants for a class, all students who are taking the same class now in the same school, all students who are taking the same course or a course that uses the same textbook in the same geographic region or in a list of schools, students who took the same class last year in the same school and received an “A” grade (e.g., students taking the course this year may be interested in seeing comments or discussions from students who performed well in this course last year).

Using a user interface displayed in a first display area, one or more users, e.g., leaders, specify one or more first documents as the base document(s), where specifying may include selecting from a list or uploading to a server, and may also include generating one or more customized documents using parts or whole of one or more other documents. The one or more first documents are made accessible to the two or more types or groups of users.

The embodiment accepts, from two or more users or two or more types or groups of users, two or more position-specific or content-specific first markups and second markups, which can be placed inside a first document in a first display area, and recording a first markup from a first user, recording a second markup from a second user, recording a specific first position at which or a specific first content to which the first markup is to be placed in a first document, recording a specific second position at which or a specific second content to which the second markup is to be placed in a first document, and a first markup or second markup may be a textual link to, or symbol, graphics, drawing, pointer, text or text box, highlighting, underline, coloring, or icon (e.g., textual or graphical) that is linked to one or more first modules that accept from users inputs related to the first or second content from one or more users over a network, or contain additional or related information, comment, correction, question, assignment, request, hint, or direction related to the first or second content accessible to a plural of users on their devices using a network connection, or a combination of the above.

Because a plural of users may add a plural of markups, the embodiment may hide one or more markups from displaying inside the first document in a first display area when the first document is read, viewed or accessed by one or more users so that markups inside the first document are not shown in a reading or viewing mode to avoid the markups by one or more users (e.g., drawings, icons, graphics, symbols, text notes, highlights, underlines, coloring, etc.) from interfering with a user's reading or viewing experience. Instead, representations of one or more first or second markups or their associated first modules may be displayed on the margin or edge or outside of the first document in the first display area or in a second display area where a representation may be a symbol, number, icon, graphics, a colored segment, or a short text. Furthermore, to distinguish a first markup and a second markup, a representation of a first markup is made different from a representation of a second markup (e.g., different color, different icon or graphics, different characters such as Q for questions, V for video, I for instruction, or a combination thereof.) so that a user can tell which markup is from which user or which type or group of users by looking at the representations without seeing what the markup is or opening the content of the markup or the associated module. When a user interacts with a first or second markup's associated representation or when a user interacts with the associated first or second content, the first or second markup is displayed inside the first document at the first or second position or near the first or second content associated with the first or second markup, where an interaction with a representation of a first or second markup may be clicking, tapping, or moving a cursor or other indicator, on the representation of the first or second markup, and an interaction with a first or second content may be clicking, tapping, or floating an cursor or other indicator, on the first or second content or displaying or viewing the first or second content.

The embodiment further comprise of opening or displaying in a second display area a first module linked with a first or second markup, or making the first module accessible to one or more users, or providing an interface for one or more users to access the first module when a user interacts with the first or second markup or a representation of the first module where interacting with a first or second markup or a representation of the first module may be clicking, tapping, or moving a cursor or other indicator, on the first or second markup or the representation of the first module. A user may view and/or enter contents in a first module. The contents in the first modules may be made searchable.

The embodiment may further comprise of selecting to show only first or second markups, or their representations, or the associated first modules made by or participated by one or more users, or a type or group of users, e.g., only show markups and modules made by an instructor of a class, by one or more specific users, by the user himself, by members of a study group, by friends in a user's social network, or in a specific time period (e.g., today, or last semester), or by students taking the class (e.g., taking the same course in the same university or at one or more of other schools in this semester or from past semesters). This enables a user to inspect categories of markups or modules separately or filter out markups and modules that may be of interest to him. For example, a student may choose to see markups or modules created by an instructor which may contain assignments or hints. Vice versa, an instructor may choose to see markups created by a specific student or a specific group of students to see what questions they have. In yet another embodiment, a mechanism, e.g., a link, a button or a list may be provided for a user to quickly access only those pages which have markups or modules associated. This is useful when a document is long and a user wants to see what contents have markups or modules associated. This may be combined with the selection of markups or modules by one or more users, or a type or group of users.

In one embodiment, a user may specify that a markup or module is to be shown only to one or more specific users, or only to a type or group of users, and only the specified users will see the existence of and access the markup or module. This provides a mechanism for one user to ask questions or communicate with one or more specific users about the content associated with the markup or module.

It may further comprise a user of one type or group selecting parts from a first document to generate a sub-document and providing a markup with a first link inside the first document or a second link outside the first document wherein when the first link or second link is clicked, the sub-document is displayed. It may also open a discussion module focused on the content of the sub-document. In some cases, the sub-document may be generated using contents from other documents other than the first document. Examples include an instructor selecting reading material, selecting or entering homework problems or questions to be answered to make us a reading assignment or homework assignment.

In one embodiment, an instructor selects one or more parts in a first document and mark them with a label, generate a link to all contents marked with the same label, when this link is clicked or interacted upon, all contents marked with the same label or tag are displayed. It may be displayed as a single document that may be printed or downloaded.

For example, an instructor may select problems or sections or paragraphs in a textbook place a markup labeled as “Today's Homework Assignment” or “This Week's Reading Assignment”, and when a student clicks on the link, only parts of the document(s) that are marked as belonging to this week's reading assignment or problems in today's homework assignment are pulled out, organized together and displayed to a student. Instead of flipping through the pages to find them, they are organized into a single document for the student study. Additional markups may be placed inside the sub-document. For example, a markup may be placed at or near a homework problem to provide hints or links to related material.

In one embodiment, a user of a first type or group may make a first markup in a first document that requires a response from one or more users of a second type or group, and a user of a second type is prompted to provide a response in the module linked by the first markup. The prompt may be displayed to a user of a second type when the user access the first document, or the an electronic message such as email, text message, IM, may be sent to the one or more users of a second type to inform them that they need to access the module linked by the first markup to provide a response. It may further comprise a user of a first type assigning a grade to the response of a user of a second type. An example is an instructor assigning questions about a part of a first document that are to be answered by students taking a class using the first document as a textbook.

In one embodiment, a module can be shared among the same type of users, e.g., discussion among a group of students; from one type of user to another type of user, e.g., a question or hint from an instructor to one or more students, an answer from a student to an instructor; or for one-to-one communication regarding the content at or near a markup from one user to another user.

One embodiment provides an interface for a user to filter markups or modules based on the type or group or individual users who created, or inputted information, or are the intended audience. For example, a user may select to see only markups and modules from students taking the same course in the same department, from a person's study group, from all students who are taking a course using the same textbook in the country, from students who took the course the previous year, from instructors at one or more universities teaching a course using the book.

A markup by one type or group of users may be made accessible to only one type of users or one individual user. For example, a student may create a markup and the associated module to ask the instructor a question. An instructor may create a markup and the associated module to ask one or more students to answer one or more questions related to the content related to the markup. When a student enters the answer, only an instructor is able to see the answer. An instructor may assign a grade or points to the answers entered by students, and the grade or points assigned to each student for answering the questions may be recorded and entered into a grade record for the students.

A user of one type can set a markup and the associated module as mandatory for another type of users, e.g., an instructor can create a markup and the associated content and mark it as mandatory for student users taking the course from the instructor. An electronic message notice may be sent to the student users to ask them to access the module and a record may be kept as to who have or have not accessed the mandatory module. In one embodiment, a markup set as mandatory for a type of users is automatically displayed to a user of the type and cannot be hidden until the user has read or accessed the content or entered information in the modules linked with the mandatory markup. A mandatory markup is displayed inside the document to a user who is an intended recipient of the mandatory markup when the user reads the content associated with the mandatory markup. A user of a type of a lower class cannot hide a mandatory markup created for the type of lower class user(s) by a type of user of higher class before a lower class user has read the content in the modules associated with the markup. For example, a student cannot hide a markup created for the class by an instructor before reading it.

When a student reads to a part in a document in which an instructor marked a question to be answered, the question may be displayed to the student, e.g., in a pop-out window, and asks the student to enter an answer. When a student enters an answer, it may be made visible to an instructor for grading. A student may also enter a question for the instructor if he is not clear of what is asked or is not sure how to answer the question.

In one embodiment, a limitation may be placed on the access to a first markup or a first modules or both, e.g., visibility of the markup or access to the modules may be limited to be private one-to-one (that is, only two users can access it and use it to have a discussion or exchange information or opinions), private group (a group of users can access it and use it to have a discussion or exchange information or opinions), public open read and write (open access and everyone can access, read and add content), public open read but limited write (open read access to everyone but only one or a group of users can write or add content).

The above embodiments provide a method for an instructor to customize or personalize reading assignments, homework assignments, questions, notes, and comments for an individual student or a group of students. This supports customized instruction that matches the capability and background of individual students.

Using the markups and the linked modules, an instructor can insert questions, notes, comments, live links to correlate different resources, including books or documents by a plural of authors and documents made by the instructor. Markups and the associated modules may be used to link contents in a book to homework problems or lab experiments that use or reinforces the contents in the book, or to link homework problems or lab experiments to contents in the book understanding of which is required in order to solve the problem or perform the lab experiment. In one example, a markup and module may be used to indicate “this homework problem is related to the paragraph(s) or part(s) of the book listed below”, followed by one or more excerpts of the related content in the book or by links which when clicked will call out the related content in the book. In another example, a markup and modules may be used to indicate “this lab experiment will help you understand of this paragraph(s) or part(s) of the book” and the named lab experiment is described in the module or a link is provided in the module clicking which will call out the instruction of the named lab experiment. An instructor can also use markups and modules to link parts of a lab experiment or homework document to different parts in one or more textbooks.

In another embodiment, a user may subscribe to a first module so that when new information is added or a change is made to the module or its content, e.g., a question is answered, a new reply, note or comment is added, a notification may be sent to a subscriber. A user may also subscribe to a portion of the content in a first document so that when a new markup and module is added to the content, a notification may be sent to the user.

Different shape or color or graphics may be used to represent the representation from different types or groups of users. Different shape or color or graphics may also be used to represent the representation of different types of markups or contents of the associated modules (e.g., agreeing or disagreeing with the first or second content associated with the markup, the module contains video or audio, etc.). One embodiment uses a representation that has two fields (e.g., a bar with two colors), wherein one field represents the user or user type, and another field represents the type of markups or contents of the associated modules.

When a reader, e.g., a student, marks up a first content and asks question in the associated module, a notice or the question itself may be sent to a leader, e.g., an instructor or teaching assistant, by email or other electronic message. When the leader answers the question, the answer may be posted in the modules and kept in context with the content. A notice or the answer may be sent to the student who asked the question. A leader may answer the question be replying to the message, and the system will post the answer in the module. When a reader asks a question about a first content, a notice or the question may also be sent to a group of users, e.g., members of a study group, or students in the same class, by email or other electronic message. Then anyone in the group may provide an answer. The embodiment may also provide a link to a leader, e.g., “Show all unanswered questions asked by students”, which when clicked will show to the leader all unanswered questions marked up by students.

If a first document contains active content, e.g., video, audio, animation, when a first module is opened, activated or displayed in a second display area, in one embodiment, the active content of a first document is paused. Upon closing or deactivate the first module and returning to the first document, the active content of a first document resumes from where it was paused.

Although the foregoing descriptions of the preferred embodiments of the present inventions have shown, described, or illustrated the fundamental novel features or principles of the inventions, it is understood that various omissions, substitutions, and changes in the form of the detail of the methods, elements or apparatuses as illustrated, as well as the uses thereof, may be made by those skilled in the art without departing from the spirit of the present inventions. Hence, the scope of the present inventions should not be limited to the foregoing descriptions. Rather, the principles of the inventions may be applied to a wide range of methods, systems, and apparatuses, to achieve the advantages described herein and to achieve other advantages or to satisfy other objectives as well.

What is claimed is:

1. A method for using a second device as a companion device to a first device to provide or enhance functions that are better supported using two or more display areas and/or I/O interface concurrently comprising
Using a companion device with a first processor and local memory for running one or more programs and a user interface for displaying and/or entering information;
A communication link between the first device and the companion device, which can be through a wired or wireless communication module embedded in the first device and the companion device and coupled to each's processor; and,
A first program running on the first device and a second program running on the companion device whereas the two programs communicate via the communication link to coordinate the content or information displayed or entered on the companion device with the content or information concurrently displayed or entered on the first device.

2. The method in claim 1 whereas entering information include one or more of typing or otherwise entering texts, drawing on a touchscreen using a finger or stylus, taking a picture or video using a camera embedded in a first or companion device, recording an audio message, importing a picture, video or audio file from a gallery or folder stored in a tablet or companion device or from a URL.

3. The method in claim 1 whereas the first program is for a user to read a book and the second program is for the user to write one or more notes about one or more places or contents on the page of the book on the first device, and the first program and the second program communicate and automatically link a note with the page or a place or content in the page the user is reading.

4. The method in claim 3 further comprising an interface that allow a user to link a note to a place or content by tapping, clicking or otherwise indicating the place or select the content on the first device, and after a page, or a place or content on a page is linked to a note, the next time the user flips to the same page of the book on the first device, the linked note is automatically displayed on companion device, and when the user flips to the same note on the companion device, the linked page or linked place or content in a page is automatically displayed on the first device.

5. The method in claim 3 further comprising an interface for a user to select a content displayed on the first device and instruct first app to send the selected content to the second app in a companion device via the communication link, and second app receives the content and includes it in a note.

6. The method in claim 3 further comprising an interface that allows a user to designate multiple notes as corresponding to a place or content in a book, or designate a note to correspond to multiple places or contents in a book.

7. The method in claim 3 further comprising accepting notes entered by multiple users and making one or more notes entered by one user accessible by other users in a group whereas notes entered by different users are distinguished in display,

8. The method in claim 1 whereas the communication link is a wireless link and more than one companion devices are linked to a first device or more than one first device is linked to a companion device.

9. The method in claim 1 further comprising displaying a keyboard on the touchscreen of a companion device and using it as a wireless keyboard for the first device.

10. A method for reading or learning in a group using mobile devices comprising
Accepting a user's selection of a first document;
Accepting from a user a first markup placed in a first document associated with a first content that is at a specified position or contains specific information, and a first app or a second content in a first app to be linked to the first markup;
Hosting on one or more servers connected to a first network the first markup, the first content to which the first markup is to be placed, and the first app or the second content in a first app and linking the first app or the second content in a first app to the first markup;
Activating or executing the first app or displaying the second content in the first app when a user accesses or views a first content in a first document or interacts with a first markup using a device connected to the first network.

11. The method in claim 10 whereas a first document contains active content, including video, audio or animation, when a user interacts with a first markup that is linked with a second content or first app that also contains active content, the active content of the first document is paused while the second content or first app is played, and upon closing or completion of the second content or first app, the active content of the first document resumes from where it was paused.

12. The method in claim 10 further comprises using a marking scheme that distinguishes the first markups based on their creator, type, ranking, date, content or a combination thereof.

13. The method in claim 10 further comprises an interface for a user to select which first markups and/or the associated first apps to show based on their creator, type, ranking, date, content or a combination thereof.

14. The method in claim 10 further comprises providing a directory and/or a search interface of the first apps and/or the second contents for one or more first documents indicating the first contents to which they are associated, and allowing a user of a first document to find, select, request to gain access to, add the second contents, or install the first apps.

15. The method in claim 10 further comprises a development interface or API so that a content and/or first app developed by a developer using the development interface or API can work on devices of multiple types of devices.

16. A method for reading or learning in a group comprising
Classifying users into two or more types, one of which is of a leader type that has rights to control the activity of or issue demand to other type(s) of users;
Accepting a user's selection of a first document;
Accepting from a user a first markup placed in a first document associated with a first content that is at a specified position or contains specific information, a first app or a second content to be linked to the first markup, and condition(s) based on which decision is made on whether the first markup and the associated first app or second content should be made visible or accessible to a user;
Hosting on one or more servers connected to a first network the first markup, the first content to which the first markup is to be placed, and the first app or the second content and linking the first app or the second content to the first markup;
Activating or executing the first app or displaying the second content when a user accesses or views a first content in a first document or interacts with a first markup using a device connected to the first network and the condition(s) for making the first markup and the associated first app or second content visible or accessible to the user is (are) met.

17. The method in claim 16 further comprises using a marking scheme that distinguishes the first markups based on their creator, type, date, content or a combination thereof.

18. The method in claim 16 further comprises providing a search interface of the first apps and/or the second contents and allowing a user of a first document to find first apps or second contents meeting parameter(s) of the search, creator, type, date, content or a combination thereof.

19. The method in claim 16 further comprises accepting selection by a user two or more parts in a first document, link them with a first markup, whereas when a user interacts with this first markup, all contents linked with it are displayed, arranged in sequence, and can be printed or downloaded as a single document.

20. The method in claim 16 further comprises accepting from a user a first markup placed in a first document associated with a first content that is at a specified position or contains specific information, a second content to be linked to the first markup, imposing a condition that one or more other users must provide a response to the second content, and when such a user accesses the first document, a notice is displayed that requires him to provide a response.
